(19) United States
(12) Patent Application Publication
(10) Pub. No.: US 2015/0150196 A1
(43) Pub. Date: Jun. 4, 2015

(54) Lawn Molds

(71) Applicant: Emmanuel Beaufort, Huger, SC (US)

(72) Inventor: Emmanuel Beaufort, Huger, SC (US)

(21) Appl. No.: 14/560,208

(22) Filed: Dec. 4, 2014

Related U.S. Application Data
(60) Provisional application No. 61/911,553, filed on Dec. 4, 2013.

(51) Int. Cl. A01G 7/06

(52) U.S. Cl. CPC A01G 7/06

(57) ABSTRACT

The present invention provides a lawn mold and method for creating lawn markings using enclosed portions of uncut grass. The lawn mold includes one or more enclosures having an upper surface, a peripheral edge around the upper surface, one or more sidewalls, and an open lower end. The sidewalls extend substantially perpendicularly and downwardly from the upper surface along the peripheral edge thereof. The upper surface of each enclosure form a character shape and form an open interior volume therein. The sidewalls include a pair of aligned apertures, wherein an elongated plank is configured to be received by the aligned apertures for aligning one or more enclosures in an aligned arrangement to form a desired message. The open lower end engages the lawn and protects a patch of grass therein. A user mows therearound to substantially form characters on the lawn.

### CROSS REFERENCE TO RELATED APPLICATION

This application claims the benefit of U.S. Provisional Application No. 61/911,553 filed on Dec. 4, 2013. The above identified patent application is herein incorporated by reference in its entirety to provide continuity of disclosure.

### BACKGROUND OF THE INVENTION

### Field of the Invention

The present invention relates to lawn maintenance. More specifically, the present invention pertains to an improved lawn molding device that allows an individual to form a message on a lawn. The present invention comprises one or more enclosures aligned by a plank designed to engage a patch of grass and receive grass therein. A user mows the lawn therearound substantially forming characters on the patch of grass.

A lawn outside a home has curb appeal. Especially, an attractive and visually pleasing lawn can draw a buyer in to view a home that they might not normally consider. A nicely manicured lawn with a matching landscaping can create initial draw and attraction. On the other hand, many homeowners, not in the market to sell their home, strive for the perfect, green lawn that their neighbors would envy. Lawn care requires a dedicated effort consisting of fertilization, and regular maintenance and repair.

Traditionally, people want to have the best lawn in the neighborhood as there is always friendly competition amongst neighbors. However, just having the greenest grass and best manicured lawn may be vanilla. There should be other methods that provide an interesting yet still well-kempt lawn. In addition, over holidays, decorations can be very extravagant. However, the lawn is never incorporated within a decoration. For example, during the Christmas season, there are people that get very excited about decorating various parts of their house including their front yard with an extravagant display. In this way, the lawn could provide another outlet for holiday décor.

The present invention provides a solution to these problems and provides a lawn mold that allows a homeowner to form messages on a lawn. Marking a message onto the lawn provides a different spin on the neighborhood competition for best lawn and also provides another outlet for seasonal decorations. The lawn mold includes one or more enclosures having an upper surface, a peripheral edge, one or more sidewalls, and an open lower end. The upper surface of each enclosure form a character and form an open interior volume therein. The sidewalls include a pair of aligned apertures, wherein an elongated plank is configured to be received by the aligned apertures for securing one or more enclosures in an aligned arrangement to form a desired message. The open lower end engages the lawn and protect a patch of uncut grass therein. A user mows the lawn around the enclosures to substantially form characters on the lawn.

### Description of the Prior Art

Devices have been disclosed in the prior art that relate to grass guards that protect pre-installed objects and mulch packets for application to soil surrounding a plant. These include devices that have been patented and published in patent application publications. Devices in the prior art disclose a grass guard that is installed around a pre-installed object. Other prior art devices disclose a mulch packet that surrounds a plant with mulch, fertilizer and other additives. These devices, however, do not disclose a lawn mold for creating lawn markings using enclosed portions of uncut grass. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,678,353 to Tsao is a grass guard installed around a pre-installed object, such as sprinkler heads, and fire hydrants, to minimize vegetation growth around the object. The Tsao device is disk-shaped with a center hole to fit over an existing sprinkler head. The Tsao device has two layers: top layer being a plastic sheet that simulates normal grass and the bottom layer is a gritty powder substance like sand bonded to the top layer with a polymer. Therefore, the Tsao device does not disclose a lawn mold having one or more enclosures designed for creating lawn markings using an interior volume that receives uncut grass.

Similarly, U.S. Pat. No. 2,782,561 to Smith is a tree surrounding ring adapted to guard the tree itself. The Smith device discloses a ring integrated into one piece with substantially a reverse U-shape cross section, which forms an outer wall and an inner wall. The Smith device further discloses detachable connecting ends that integrate the ring into one piece. Distinct from the current device, the Smith device does not disclose an enclosure having an upper surface, a peripheral edge, one or more sidewalls, and an open lower end to form an open interior volume for receiving uncut grass therein.

U.S. Pat. No. 3,857,195 to Johnson is a mulch packet applied to the soil surrounding a plant. The Johnson device discloses a perforated base sheet of water impermeable material that allows water to trickle downward through the series of small holes into the soil. The Johnson device also includes a cover layer that is attached to the base sheet on the periphery and central area of the device. Mulch material is located within the compartment between the base sheet and the cover layer. The central portion of the packet is a series of concentric rings and a radial slit connects rings to the periphery of the packet. Therefore, the Johnson device does not disclose a lawn mold that is removably secured on the lawn to be mowed therearound.

U.S. Pat. No. 1,554,865 to Eaton discloses two sheets of paper attached together to form a hollow ring. Within the ring is a body of soil nutrients and ingredients. The Eaton device is placed around a plant slightly above ground level to protect the plant from sunlight and the growth of weeds. The Eaton device, however, does not disclose a lawn mold having an upper surface shaped in the form of a character.

The devices disclosed in the prior art have several known drawbacks. These devices are limited to purposes for protecting an existing fixture or providing mulch and fertilizer to a plant. Some devices disclose a grass guard installed around a pre-installed object, such as a sprinkler head. Other devices disclose a hollow ring to provide nutrients to a plant. The present invention overcomes these limitations by disclosing a lawn mold for creating lawn markings, specifically forming characters organized into a message.

The lawn mold includes at least one enclosure having an upper surface, a peripheral edge, one or more sidewalls and an open lower end. The upper surface and sidewalls form an open interior volume designed to receive a patch of uncut grass therein. The sidewalls extend substantially perpendicularly and downwardly from the peripheral edge of the upper surface. The upper surface and sidewalls are shaped in the form of a character shape. The sidewalls further comprise of a pair of aligned apertures, wherein an elongated plank is configured to be inserted therethrough for securing the enclosures in a desired arrangement to form a message. The open lower end is designed to be placed plush on a patch of uncut grass. A user then mows the lawn around the enclosures to from a message on the lawn. It is therefore submitted that the present invention is substantially divergent in design elements from the prior art, and consequently it is clear that there is a need in the art for an improvement to lawn care and maintenance. In this regard, the instant invention substantially fulfills these needs.

### SUMMARY OF THE INVENTION

In view of the foregoing disadvantages inherent in the known types of lawn molds now present in the prior art, the present invention provides a new and improved lawn molds wherein the same is designed to create lawn markings with the use of enclosed portions of uncut grass.

It is therefore an object of the invention to provide a new and improved lawn mold that has all of the advantages of the prior art and none of the disadvantages.

Another object of the present invention is to provide a new and improved lawn mold that comprises one or more enclosures having an upper surface, a peripheral edge, one or more sidewalls, and an open lower end forming an open interior volume.

Yet another object of the present invention is to provide a new and improved lawn mold wherein the upper surface is shaped in the form of a character shape.

Still yet another object of the present invention is to provide a new and improved lawn mold wherein the sidewalls comprise a pair of apertures designed to receive an elongated plank for securing at least one of the enclosures in a desired arrangement to form a message aligned by the plank.

Another object of the present invention is to provide a new and improved lawn mold wherein the lower open end is designed to engage and be placed plush on a patch of uncut grass on a lawn.

A further object of the present invention is to provide a new and improved lawn mold wherein a user mows the lawn around the enclosures substantially forming a desired message.

Yet a further object of the present invention is to provide a new and improved lawn mold that is easy to use and removably secured to the lawn.

Still yet another object of the present invention is to provide a new and improved lawn mold wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows an overhead view of the present invention as secured to the lawn.

FIG. 2 shows an overhead view of a second embodiment of the present invention as secured to the lawn.

FIG. 3 shows an overhead view of the finished product of the present invention.

FIG. 4 shows an overhead view of the underside of one embodiment of the present invention.

### DETAILED DESCRIPTION OF THE INVENTION

References are made herein to the attached drawings. Like reference numerals are used throughout the drawings to depict like or similar elements of the lawn mold. For the purposes of presenting a brief and clear description of the present invention, the preferred embodiment will be discussed as removably secured to a lawn. The figures are intended for representative purposes only and should not be considered to be limiting in any respect.

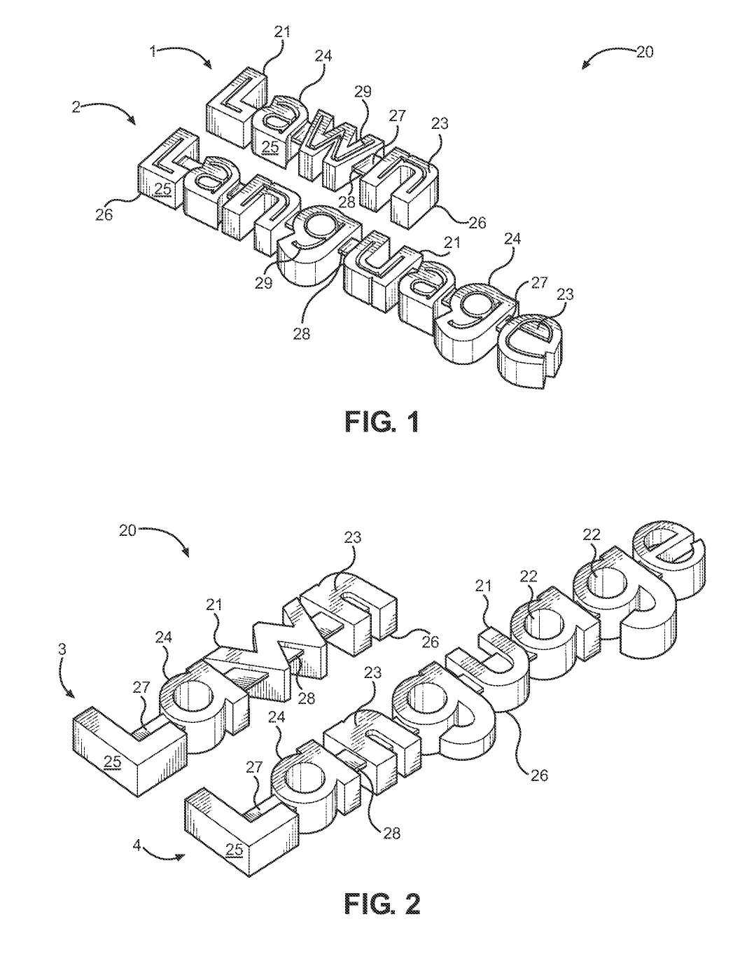

Referring now to FIGS. 1 and 2, there are shown a pair of overhead views of embodiments 1, 2, 3, 4 of the lawn mold 20. The lawn mold 20 comprises one or more enclosures 21 having an upper surface 23, a peripheral edge 24 around the upper surface 23, an open lower end 26, and one or more sidewalls 25. The sidewalls 25 extend substantially perpendicularly and downwardly from the upper surface 23 along the peripheral edge 24 thereof. The sidewalls 25 and upper surface 23 form an open interior volume. The upper surface 23 of each enclosure 21 is shaped in the form of a character shape. The sidewalls 25 further comprise a pair of aligned apertures 27 therethrough, wherein an elongated plank 28 is configured to be inserted therethrough for aligning at least one or more enclosures 21 in a desired arrangement to form a message based on the character shape of the enclosure 21 aligned by the plank 28. Lawn mold 20 is designed to place open lower end 26 plush to a patch of uncut grass of a lawn and with the open interior volume receiving uncut grass therein. Lawn markings are created by lawn mold 20 when a user mows the lawn therearound.

The enclosure 21 has a hard and durable surface that is in the form of a character shape. Characters further comprise a symbol, a number or a punctuation mark. The enclosures are arranged and aligned on elongated plank 28 to form any desired message based on the user's preference. In some embodiments, like the embodiment 2 of FIG. 2, the upper surface 23 may further comprise of slits 29 therein. The slits 29 are designed to allow water and sunlight to enter, thereby allowing grass to grow in the enclosure 21. The slits 29 are also shaped in the form of a character shape for more design appeal.

In some embodiments, enclosures 21 further comprise interior walls within the interior volume forming specific characters, such as “a” and “g.” Interior walls 22 allow sunlight and water to enter, thereby allowing grass to grow therein. A user can use a brush cutter, grass trimmer, or other suitable devices to trim the grass enclosed by an interior sidewall 22 to clearly delineate a specific character of an enclosure 21. Sidewalls 25 and interior walls 25 are sufficiently tall enough to allow grass to grow therein while protecting the same, while a user is mowing therearound, whereby the grass growing therein forms a character over time. The difference in length between the freshly cut areas therearound, and the enclosed grass therein is based on personal preference. Depending on user preference, a user may prefer a larger or smaller discrepancy between the cut and uncut patches of grass.

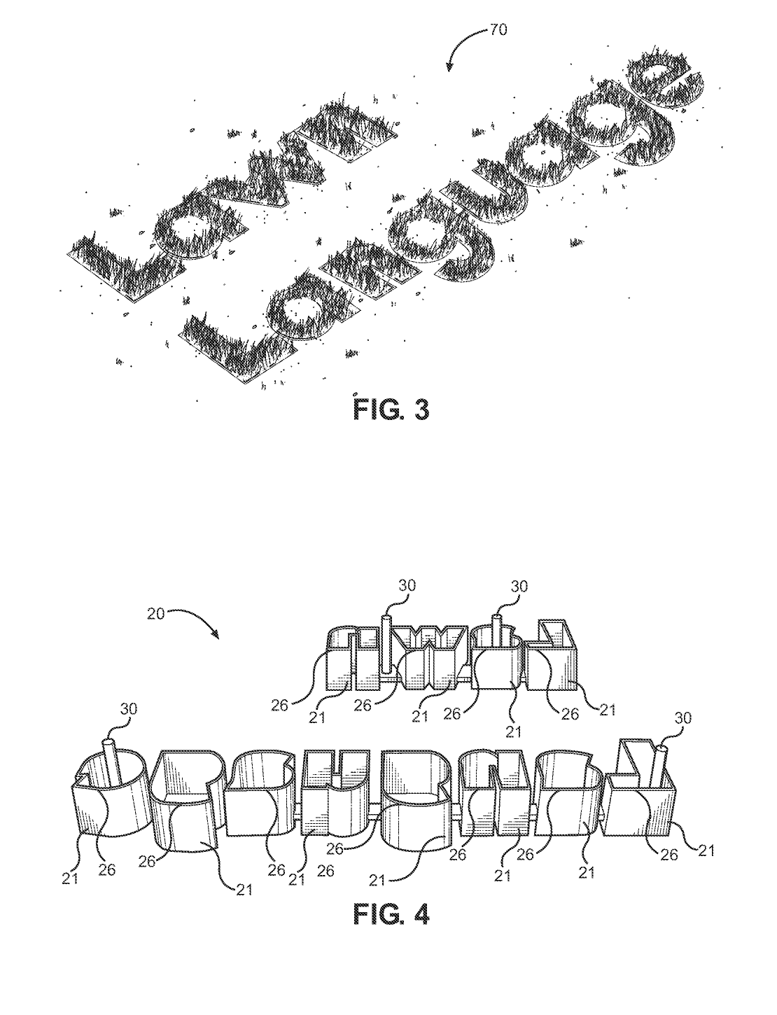

Referring now to FIG. 3, there is shown an overhead view of the finished product 70 after the lawn mold is unsecured from the lawn. Lawn mold is designed for a user to engage and place plush the open lower end of the enclosure on a patch of uncut grass. The grass enclosed therein are protected therein, thereby preventing the enclosed portions from being cut and remaining uncut. A user mows and trims therearound the sidewalls of the enclosures to form characters on the lawn.

The enclosures can be aligned together to form words, acronyms, phrases and sentences. When a user removes the molds thereon, the uncut grass therein the open interior volume of the enclosure remain unharmed, and create characters strung together into words. The length of the uncut grass therein the open interior volume is a matter of preference, as is the length of the cut grass around the lawn molds.

Referring now to FIG. 4, there is shown the open lower end 26 of the molds 20. The plank 28 further comprises at least one stake 30 to engage the lawn to stabilize one or more enclosures 21. The stakes 30 are integrally formed on substantially the both ends of the plank 28. The stakes 30 are vertical rods extending downwardly and perpendicularly from the plank 28. The stakes 30 are designed to be removably secured into the lawn by pressing the stakes 30 downwardly into the lawn until the open lower end 26 of the enclosure 21 is placed plush to a patch of uncut grass of a lawn. The open interior volume encloses an area of grass therein each enclosure 21 after the enclosure 20 is placed plush to the lawn. A user can then mow therearound and trim within the slits to create a message using uncut portions of a lawn.

Each enclosure 21 is composed of a sturdy plastic material such as polycarbonate. Other embodiments, without limitation, use other suitable heavy duty plastics such as a blend of polycarbonate and acrylonitrile butadiene styrene. The plank 28 and stakes 30 are composed of a rust-free aluminum, however, without limitation, other embodiments use any suitable corrosion-free metal.

According to the preferred embodiment, the mold 20 further provides a method of creating lawn markings comprising the steps of:
selecting an arrangement to form in a patch of grass using one or more enclosures having a character shape, said enclosures having an upper surface, one or more said sidewalls, and an open lower end that forms an open interior volume;
placing said open lower end of each enclosure on a patch of grass to form said arrangement;
trimming around each enclosure;
allowing grass to grow within said open interior volume of each enclosure;
removing said one or more enclosures to reveal said arrangement on said patch of grass.

Accordingly, the method of creating lawn markings further comprising the steps of:
using an elongated plank that is configured to be received by aligning apertures for aligning said one or more enclosures in a said arrangement for form a message based on said character shape of each said enclosure;
securing said one or more enclosures to the ground using said plank having at least one stake designed to engage a lawn until said lower end of said one or more enclosures are placed plush to said lawn.
It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A lawn mold for creating lawn markings using enclosed portions of uncut grass, comprising:
one or more enclosures having an upper surface, a peripheral edge around said upper surface, and one or more sidewalls;
said sidewalls extending substantially perpendicularly from said upper surface along said peripheral edge thereof;
said sidewalls and upper surface forming an open interior volume;
said one or more enclosures having an open lower end;
said upper surface of each enclosure shaped in the form of a character shape;
said sidewalls having a pair of aligned apertures therethrough;
an elongated plank configured to be received by said aligned apertures for aligning said one or more enclosures in a desired arrangement to form a message based on said character shape of each enclosure.

2. The lawn mold of claim 1, wherein said character shape further comprises one of a symbol, number, or punctuation mark.

3. The lawn mold of claim 1, wherein said plank further comprises at least one stake perpendicularly extending therefrom to engage a surface below said one or more enclosures to stabilize said one or more enclosures.

4. The lawn mold of claim 1, wherein said stake is designed to be removably secured to a lawn by pressing downwardly until said lower end of said enclosure is plush to said lawn.

5. The lawn mold of claim 1, further comprising of interior walls within said interior volume forming a specific character.

6. The lawn mold of claim 1, wherein said sidewalls are sufficiently tall enough to allow grass to grow therein while protecting the same while a user is mowing therearound, whereby the grass growing therein forms a character over time.

7. The lawn mold of claim 1, wherein said upper surface further comprises slits therein to allow water and sunlight to enter, thereby allowing grass to grow within said enclosure.

8. A method of creating lawn markings, comprising the steps of:
selecting an arrangement to form in a patch of grass using one or more enclosures having a character shape, said enclosures having an upper surface, one or more said sidewalls, and an open lower end that forms an open interior volume;
placing said open lower end of each enclosure on a patch of grass to form said arrangement;
trimming around each enclosure;
allowing grass to grow within said open interior volume of each enclosure;
removing said one or more enclosures to reveal said arrangement on said patch of grass.

9. The method of claim 8 further comprising:
using an elongated plank that is configured to be received by aligning apertures for aligning said one or more enclosures in a said arrangement for form a message based on said character shape of each said enclosure.

10. The method of claim 8 further comprising:
securing said one or more enclosures to the ground using said plank having at least one stake designed to engage a lawn until said lower end of said one or more enclosures are placed plush to said lawn.
